(19) United States
(12) Patent Application Publication
(10) Pub. No.: US 2009/0129835 A1
(43) Pub. Date: May 21, 2009

(54) BELT TYPE IMAGE FIXING DEVICE AND IMAGE FORMING APPARATUS USING THE SAME DEVICE

(75) Inventor: Hiroshi FUNABIKI, Uenohara-shi (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/270,940

(22) Filed: Nov. 14, 2008

(30) Foreign Application Priority Data
Nov. 19, 2007 (JP) JP2007-298997

(51) Int. Cl. G03G 15/20

(52) U.S. Cl. 399/329

(57) ABSTRACT

A belt type image fixing device, including: an image fixing endless belt, having: an electrically conductive layer; and an insulation layer to cover the electrically conductive layer; a pressure applying member to press against the image fixing endless belt, having: an electrically conductive layer; and an insulation layer to cover the electrically conductive layer; and an electrical voltage applying device which applies an electrical voltage to the electrical conductive layer of the image fixing endless belt, and to the electrical conductive layer of the pressure applying member, wherein the image fixing endless belt and the pressure applying member form a nipping portion which nips and conveys a recording medium carrying a toner image, and wherein a predetermined difference of electrical voltage is created between the image fixing endless belt and the pressure applying member, so that the recording medium is evenly nipped, and the toner image is evenly fixed.

### CROSS REFERENCE TO RELATED APPLICATION

This application is based on Japanese Patent Application No. 2007-298997 filed on Nov. 19, 2007, in the Japanese Patent Office, the entire content of which is hereby incorporated by reference.

### TECHNICAL FIELD

The present invention relates to a belt type image fixing device incorporating at least an image fixing endless belt, and to an image forming apparatus using the same belt type image fixing device.

### BACKGROUND OF THE INVENTION

In the image forming apparatuses using an electro-photographic method, such as a copy machine, a printer, and a compound machine incorporating various functions of the above, after a latent image corresponding to a document is formed on a photoconductor, toner is applied to said latent image to be visualized, whereby said visualized toner image is transferred onto a recording sheet, after which said transferred image is permanently fixed on the recording sheet, and the recording sheet carrying the fixed image is ejected from the image forming apparatus.

In a case of forming full-color images, after latent images of Y, M, C and K, corresponding to each color of the document, are formed on four respective photoconductor drums of a color image forming apparatus, color toner particles of Y, M, C and K, are respectively applied to said latent image to be visualized, whereby said visualized images, carrying the toner particles of each color, are primarily transferred onto an intermediate transfer member formed of an endless belt, to become a full-color image, after which said full-color image is secondarily transferred onto the recording sheet to be permanently fixed, and the recording sheet carrying the permanently fixed color image is ejected from the color image forming apparatus.

As the above-described image fixing device to fix the toner image on the recording sheet, a belt type image fixing device is well-known, in which the recording sheet is sandwiched and conveyed between paired endless belts, so that the toner image transferred on the recording sheet is permanently fixed.

For example, Unexamined Japanese Patent Application Publication No. 2004-206079 discloses a belt type image fixing device, in which a recording sheet carrying toner image is sandwiched between two endless belts. One of the endless belts is entrained about a heating roller, incorporating a heater, and an upper guide roller, and the other is a pressure applying endless belt, entrained about two lower guide rollers. The toner image carried on said recording sheet is pressed and conveyed between said two belts, and is permanently fixed.

By said belt type image fixing device, the sheet nipping width can be increased so that the degree of brilliance on the surface of the recording sheet increases, which is preferable for fixing the color image, and the sheet conveyance speed is also increased. Further, the heat capacity can be controlled to be lowered to heat the image fixing belt, which promotes energy savings. Still further, the warming-up time of the image fixing device is shortened.

In the above-described belt type image fixing device, if the belts and the rollers, entraining the belts, are formed with a high degree of accuracy, any undesirable problems do not occur. However, due to manufacturing errors, such as 10-20 μm change of the belt thickness, the change in hardness of the inner surface of the belt and the outer surface of the rollers, a few μm error of the roller straightness, and approximately 10 μm diameter change of the rollers, the belts entrained about the rollers tend to result in wave undulation during the rotation. Further if the rollers are declined even less than 1% in the axial direction due to the weight, the belts also tend to waver and undulate. Still further, regarding a means to apply tension to the belt, the tolerance of the spring constant of a normal spring is approximately 10%, so that the belts tend to waver and undulate. Accordingly, except special belts and rollers which are produced for experimental work with a high degree of accuracy, if belts and rollers produced for normal work are employed in the image fixing device, non-contacting areas are created at the nipping portion between the paired belts. Due to said non-contacting areas, non-pressured areas occur, where the toner image transferred on the recording sheet is not effectively pressed, so that the toner particles tend to move, or air flow tends to enter into said non-contacting areas, which results in defected image fixing. Further, desired production accuracy to counter this problem becomes very high, resulting in higher production cost.

As another method to overcome the above problem, sliding members are employed which sandwich and press the nipping portion of the belts from the inner surfaces of the belts during rotation. However, with said method it is difficult to create even pressure distribution so that the undesired image fixing problem cannot be solved, and further, said sliding members require high durability, which is also a difficult matter. Above-described Unexamined Japanese Patent Application Publication No. 2004-206079 discloses the image fixing device in which the sliding members are mounted on the inner surfaces of the belts of the image fixing device, and the sliding members sandwich the nipping portion between the paired belts. However, a non-pressuring area is produced between the guide roller and the sliding members, which area also results in undesired image fixing operation. Further, due to the sliding members, the belts and said sliding members tend to be defected by friction, which adversely exhibits the wrong durability.

Still further, in above-described Unexamined Japanese Patent Application Publication No. 2004-206,079, in order to reduce the undesired image shift due to wave and undulation of the endless belts, a negative electric charge is applied to the surface of the pressure applying endless belt, just before the endless belts pass through the nipping portion, whereby the recording sheet carrying a positive electrical charge is attracted to the pressure applying endless belt carrying the negative electrical charge.

However, even though the recording sheet is electrically attracted to the pressure belt, the deflection and the wave undulation, occurring on the image fixing belt during contact with the toner image, are not sufficiently decreased, and a non-pressuring area still remains, which prevents pressing the toner image carried on the recording sheet, at the nipping portion. Still further, since the recording sheet is electrically attracted to the pressure roller, an electrical discharging device must be mounted to electrically discharge the pressure roller just after the nipping portion, to smoothly conduct the sheet separation from the belt.

### SUMMARY OF THE INVENTION

The present invention has been achieved to overcome the various above-described problems. An object of the present invention is to provide a belt type image fixing device in which a simple method is used to evenly fix the toner image onto the recording sheet by the image fixing belt, and to provide an image forming apparatus incorporating said image fixing device.

The object described above will be attained by an invention described below.

A belt type image fixing device, including: an image fixing endless belt which is configured to include: an electrically conductive layer; and an insulation layer to cover the electrically conductive layer; a pressure applying member to press against the image fixing endless belt, the pressure applying member is configured to include: an electrically conductive layer; and an insulation layer to cover the electrically conductive layer; and an electrical voltage applying device which is configured to apply an electrical voltage to at least one of the electrical conductive layer of the image fixing endless belt and the electrical conductive layer of the pressure applying member, wherein the image fixing endless belt and the pressure applying member form a nipping portion which nips and conveys a recording medium on which a toner image has been transferred, and wherein a predetermined difference of electrical voltage is created between the image fixing endless belt and the pressure applying member.

### BRIEF DESCRIPTION OF THE DRAWINGS

FIG. 1 is a constructive figure of an image forming apparatus.

FIG. 2 is a cross-sectional view of a belt type image fixing device.

FIG. 3 is a drawing to show an image fixing belt and a pressure applying belt, the widths of which are different.

FIG. 4 is a drawing to show an image fixing belt and a pressure applying belt, which are laterally offset from each other.

FIG. 5 is a cross-sectional view of another example, incorporating an image fixing belt and a pressure applying roller.

FIG. 6 is a cross-sectional view in which the pressure applying roller is pressed against the image fixing belt.

FIG. 7 is also a cross-sectional view in which the pressure applying roller is pressed against the image fixing belt.

FIG. 8 is a cross-sectional view of a belt type image fixing device, incorporating an image fixing belt, a pressure applying roller, and a stationary contacting member.

### DETAILED DESCRIPTION OF THE PREFERRED EMBODIMENTS

Embodiments relating to the image forming apparatus of the present invention will be detailed below while referring to the drawings.

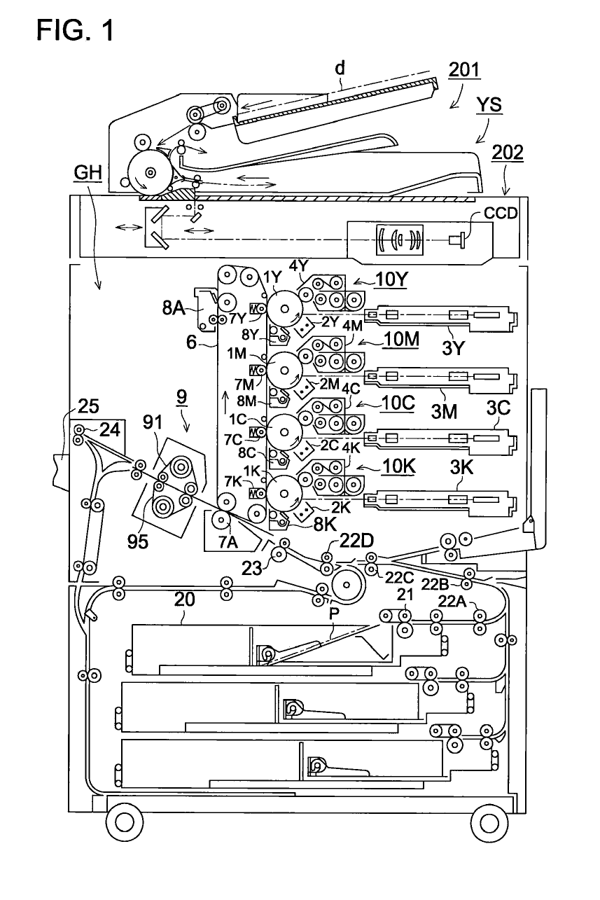

Firstly, an example of the image forming apparatus will now be detailed while referring to the constructive figure shown in FIG. 1.

The present image forming apparatus is structured of image forming main unit GH and image reading device YS.

Image forming main unit GH is called a tandem type color image forming apparatus, which includes a plurality of image forming sections 10Y, 10M, 10C and 10K, belt type intermediate transfer body 6, a sheet conveyance section, belt type image fixing device 9, and the like.

Above image forming main unit GH, image reading device YS is mounted, which is structured of automatic document feeding device 201 and document image scanning exposure device 202. Document “d”, placed on a document platen of automatic document feeding device 201, is conveyed by a conveyance section to document image scanning exposure device 202, wherein original images of a single sided or double sided document “d” are scanning-exposed so that line image sensor CCD reads the original images.

After signals of the original image, read by line image sensor CCD, is processed with respect to an analog process, A/D conversion, shading correction, and an image compressing process, said signals are sent to exposure sections 3Y, 3M, 3C and 3K.

Image forming section 10Y, which forms yellow image, includes charging section 2Y, exposure section 3Y, developing section 4Y, and cleaning section 8Y, around photo sensitive drum 1Y. Image forming section 10M, which forms magenta image, includes charging section 2M, exposure section 3M, developing section 4M, and cleaning section 8M, around photo sensitive drum 1M. Image forming section 10C, which forms cyan image, includes charging section 2C, exposure section 3C, developing section 4C, and cleaning section 8C, around photo sensitive drum 1Y. Image forming section 10K, which forms black image, includes charging section 2K, exposure section 3K, developing section 4K, and cleaning section 8K, around photo sensitive drum 1K. A latent image forming section for each color Y, M, C and K is structured of charging section 2Y and exposure section 3Y, charging section 2M and exposure section 3M, charging section 2C and exposure section 3C, and charging section 2K and exposure section 3K, respectively.

Developing devices 4Y, 4M, 4C and 4K, each includes a dual component developer of toner particles and carriers.

Intermediate transfer body 6 is entrained about plural rollers, to rotate.

In belt type image fixing device 9, image fixing belt 91 and pressure applying belt 95 are entrained about the plural rollers, respectively. The toner image, carried on recording medium P (being a recording medium), is heated and pressed to become fixed at the nipping portion formed between image fixing endless belt 91 and pressure applying endless belt 95.

Each color image, formed by image forming sections 10Y, 10M, 10C and 10K, is transferred onto rotating intermediate transfer body 6 by transfer sections 7Y, 7M, 7C and 7K, respectively (which makes up the primary transfer operation), whereby toner image, including superposed color images, is formed. Recording medium P, taken by sheet supplying section 21, is conveyed to transfer section 7A through registration roller 23, as well as sheet supplying rollers 22A, 22B, 22C, and 22D, whereby the color image is transferred onto recording medium P (which is the secondary transfer operation). Recording medium P, carrying the transferred color image, is heated and pressed by belt type image fixing device 9, so that color toner image is fixed onto recording medium P, which is conveyed by sheet ejection roller 24 onto sheet tray 25, mounted on the exterior of image forming main unit GH.

Intermediate transfer body 6, which has transferred the color image onto recording medium P, and has separated recording medium P, is further rotated to cleaning section 8A, where the toner remaining on intermediate transfer body 6 is cleaned off.

In addition, the above explanation concerns the image forming apparatus to form a full color image, however the present invention can also be applied to an image forming apparatus to form a monochromatic image.

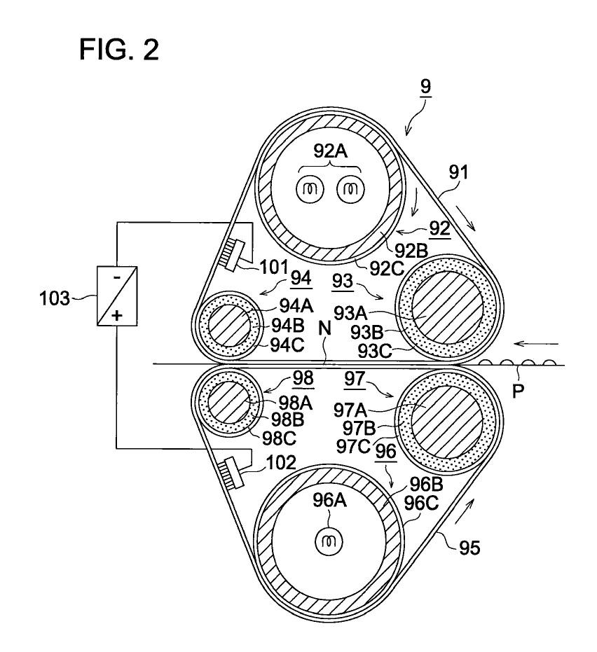

Next, an example of belt type image fixing device 9 relating to the present invention will be detailed while referring to the cross-section shown in FIG. 2.

In belt type image fixing device 9, image fixing endless belt 91 is entrained about first heating roller 92, inlet image fixing roller 93, and outlet fixing roller 94. Pressure applying endless belt 95 (which serves as a pressure applying member) is entrained about second heating roller 96, inlet pressure applying roller 97, and outlet pressure applying roller 98. Inlet pressure applying roller 97 presses against inlet image fixing roller 93 through image fixing endless belt 91 and pressure applying endless belt 95, while outlet pressure applying roller 98 presses against outlet image fixing roller 94 through image fixing endless belt 91 and pressure applying endless belt 95.

Inlet image fixing roller 93 or outlet image fixing roller 94 rotates clockwise so that image fixing endless belt 91 also rotates clockwise. Due to this rotation, pressure applying endless belt 95, pressing against image fixing endless belt 91, rotates counterclockwise. By this manner, sheet nipping portion N, formed at an area where image fixing endless belt 91 is pressed by pressure applying endless belt 95, sandwiches and conveys recording medium P. That is, the toner image having been transferred on recording medium P, being pressed against image fixing endless belt 91, is permanently fixed by applied heat and pressure.

Next, each member incorporated in belt type image fixing device 9 will be detailed.

Concerning image fixing endless belt 91 and pressure applying endless belt 95, a belt base is, for example, an electrical conductive polyimide (being carbon added polyimides), exhibiting a 70 μm thickness, or a nickel electro-casting member, exhibiting a 40 μm thickness. The outer surface of each is covered with an elastic layer, exhibiting a 200 μm thickness, being a heat-resistant silicon rubber (hardness: JIS-A15°). Further, each elastic layer is further covered with an electrical insulating surface layer, exhibiting a 30 μm thickness, which is of a heat-resistant resin, such as a tube of PTA (being perfluoroalkoxyethylene), or said elastic layer is coated with PTFE (being polytetrafluoroethylene). Still further, the outer size of each is, for example, 100 mm, that is, each contour length is 314 mm. Each endless belt in the entrained condition exhibits 60 N, for example.

First heating roller 92 and second heating roller 96 include halogen lamps 92A and 96A, serving as heating sections to heat image fixing endless belt 91 and pressure applying endless belt 95, respectively. Both rollers 92 and 96 are formed of aluminum cylindrical members 92B and 96B, at a wall thickness of 3 mm, to which surface layers 92C and 96C are applied, covered with PFA, exhibiting a 20 μm thickness, for example. The external diameter of rollers 92 and 96 is typically 60 mm.

Halogen lamp 92A is divided into two sections to distribute heat energy to all areas in the axial direction of first heating roller 92, for example, 930 W and 600 W, so that various sheet widths may be employed, while halogen lamp 96A is mounted to evenly distribute the heat in the axial direction of second heating roller 96, for example, exhibiting 530 W.

Inlet image fixing roller 93 and inlet pressure applying roller 97 include aluminum or iron cylindrical members 93A and 97A, on the outer surface of which 3 mm silicon rubber layers 93B and 97B are formed, while surface layers 93C and 97C are formed of 20 μm PFA, for example. The external diameter of both rollers 93 and 97 is typically 40 mm.

Outlet image fixing roller 94 and outlet pressure applying roller 98 include aluminum or iron cylindrical members 94A and 98A, on the outer surface of which 1.5 mm silicon rubber layers 94B and 98B are formed, while surface layers 94C and 98C are formed of 20 μm FTA, for example. The external diameter of both rollers 94 and 98 is typically 25 mm.

That is, each roller, mounted within image fixing endless belt 91, is of the same size and respective mounting position, within pressure applying endless belt 95. Each roller is symmetrically mounted within image fixing endless belt 91, and within pressure applying endless belt 95, with respect to nipping portion N.

By a mechanical structure, which is not illustrated, inlet image fixing roller 93 is pressed by inlet pressure applying roller 97, through image fixing endless belt 91 and pressure applying endless belt 95, while outlet image fixing roller 94 is pressed by outlet pressure applying roller 98. Due to this structure, between inlet image fixing roller 93 and outlet image fixing roller 94, pressure applying belt 95 presses against image fixing endless belt 91. Since each pair of rollers, mounted within image fixing endless belts 91 and mounted within pressure applying endless belt 95, has the same diameter and mounting position, nipping portion N forms a wider and flatter surface.

For example, the image fixing pressure between inlet image fixing roller 93 and inlet pressure applying roller 97 is 500 N, while the image fixing pressure between outlet image fixing roller 94 and outlet pressure applying roller 98 is 200 N.

Further, image fixing belt 91, heated by first heating roller 92, is controlled to be in the thermal range of 150° C.-210° C. Pressure applying endless belt 95, heated by second heating roller 96, is controlled to be in the thermal range of 120° C.-160° C.

As described above, since image fixing endless belt 91 and pressure applying endless belt 95 tend to slightly deflect and undulate, some areas, in which endless belts 91 and 95 do not make contact, are generated in nipping portion N. Accordingly, some areas, in which image fixing endless belt 91 does not firmly contact the toner image transferred on recording medium P, are generated in nipping portion N, allowing the toner to shift, or allowing air to enter, which results in defected image fixing.

In order to overcome this problem, brush 101 contacts the electrically conductive layer serving as the belt base of image fixing endless belt 91, so that the electrical voltage of −2500 V is applied to said belt base by constant voltage power source 103. In the same manner, brush 102 contacts the electrically conductive layer serving as the belt base of pressure applying endless belt 95, so that the electrical voltage of +2500 V is applied to said belt base by constant voltage power source 103. Due to these electrical voltages, the difference of voltage between image fixing endless belts 91 and pressure applying endless belt 95 is generated. Accordingly, image fixing endless belt 91 and pressure applying endless belt 95 are electrically attracted to each other. That is, in areas of the nipping portion N which are not tightly pressed by the rollers, both endless belts 91 and 95 contact each other uniformly. Accordingly, the toner image, transferred on recording medium P, is evenly fixed, while sandwiched between image fixing endless belt 91 and pressure applying endless belt 95, so that no image fixing defects occur.

Further, nipping portion N serves like a capacitor, including the rubber layers and the surface layers of image fixing endless belt 91 and pressure applying endless belt 95, respectively, and recording medium P, wherein the belt base of image fixing endless belt 91 serves as an electrode, and pressure applying endless belt 95 serves as the electrode. Accordingly, due to the electrical voltages applied between the belt bases, firm contact is maintained between image fixing endless belt 91 and pressure applying endless belt 95.

The electrically attractive force F per unit area between the belt bases is shown by the formula below.

F=(½)×(∈V²/d²)

∈: dielectric constant between the belt bases,

V: electrical voltage between the belt bases, and

d: distance between the belt bases.

Further, in image fixing device 9 described above, dielectric constant ∈ of the rubber layer, the surface layer and recording medium P is approximately 2-3. If recording medium P with the thickness of 80 μm is sandwiched between the endless belts, attractive force F is approximately 1 kPa. At nipping portion N, only enough force is required not to separate recording sheet P from each endless belt, so that said calculated value of 1 kPa is sufficient for the image fixing operation.

Concerning the polarity of the electrical voltage to be applied to the belt base of image fixing endless belt 91 and belt base of pressure applying endless belt 95, if a desired difference of voltage is only applied between said belts 91 and 95, from the view point of the force between the belt bases, different charges with the same polarity may be used, or one of the belt bases may be electrically grounded, or the like. However, if the toner carried on recording medium P has been negatively charged, the electric field should be controlled to work from pressure applying endless belt 95, which does not face the image side, toward image fixing endless belt 91 which faces the image side, so that the toner image will not be disturbed. Still further, if the toner carried on recording medium P has been possibly charged, the electrical field should be controlled to work from image fixing endless belt 91 toward pressure applying endless belt 95.

Still further, concerning the voltages to be applied to both belt bases, their absolute values of the voltages should be approximately equal to each other, because any difference of the voltage, between the members applying the voltage to the belt bases of the belts and the voltage carried by the relating members, become lowered, whereby electrical isolation can easily occur.

Still further, based on the Paschen effect, the electrical field in the air should be controlled to be less than 4×10⁷ V/m, so that aerial discharge does not occur, whereby image disturbance and noise occurrence due to the aerial discharge are prevented, which is preferable. In said image fixing device 9, the isolating members are not charged, but the electrical potential is controlled. The electrical potential at nipping portion N becomes greatest, that is, 9×10⁶ V/m, in which the distance between the electrical conductive layers of both endless belts 91 and 95 is shortest. Since any section, other than nipping portion N, has an electrical potential of less than 9×10⁶ V/m, no aerial discharge occurs.

Further, when the voltage endurance of each section has been enough, if a higher difference of voltage is applied within the limit to satisfy said Paschen effect, the attractive force between the endless belts becomes larger, so that lower accuracy for the components or allowed deformation during use may be effectively covered, whereby an image fixing device, exhibiting higher endurance and lower production cost, can be obtained.

Still further, in a method of applying the electrical charge to each endless belt and recording medium P by corona discharge, when sufficient pressure is to be applied at the nipping portion where mechanical pressure due to the rollers is not applied, if a member, having received an electrical charge at nipping portion N where the mechanical pressure is applied, gradually separates from the nipping portion, said member becomes to carry a different voltage which is in proportion to a separated distance, whereby aerial discharge occurs. However, in image fixing device 9 which was detailed above, the method is used, in which the difference of voltages is provided between electrical conductors. That is, the method is used, in which the difference of voltages between the members is controlled. Accordingly, the problem, occurred in the method of the corona discharge, does not occur in image fixing device 9.

Still further, as a method of applying a voltage to image fixing endless belt 91 and pressure applying endless belt 95, any roller entraining each endless belt is exposed to open metallic portions, so that the electrical voltage is applied through said metallic portions. By this method, larger connecting areas can be used, and loose connections or abnormal noise generation can be reduced.

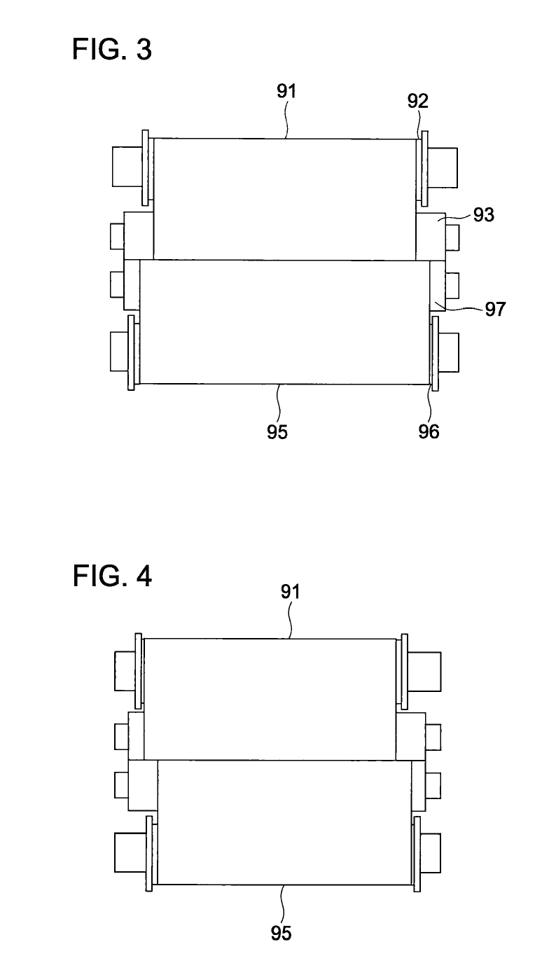

Further, at the edges of image fixing endless belt 91 and pressure applying endless belt 95, the edges of the belt bases of both endless belts 91 and 95 become adjacent, so that the electrical discharge at these marginal surfaces may occur. To prevent this electrical discharge, as shown in FIG. 3, the widths of image fixing endless belt 91 and pressure applying endless belt 95 are structured to be different, being a narrower belt and a wider belt, whereby the edges of both endless belts 91 and 95 are farther separated, and the electrical discharge at the marginal surfaces can be effectively prevented.

However, since the edges of the narrower belt are strongly pressed against the surface of the wider belt, uneven surfaces are created on the wider belt by the narrower belt, whereby the uneven surfaces on the wider belt may carry greater stress. Generally, concerning the heat-resistant resin used in the belt base of the belt, as well as the heat-resistant resin to cover the metal and the elastic rubber, the higher the temperature rises, the lower the intensity falls, and the abrasion resistance weakens. Accordingly, since pressure applying endless belt 95, which does not face the image side, can be set at the lower temperature, pressure applying endless belt 95 will be structured to be wider so that the abrasion will be preferably prevented.

As another example, which is shown in FIG. 4, the widths of image fixing endless belt 91 and pressure applying endless belt 95 are structured to be equal, but the edges of the endless belts are offset so that the electrical discharge at the marginal surfaces can be effectively prevented.

Usually, the edges of both endless belts are shifted 5 mm, but electrical discharge may still occur due to paper dust, in which case the offset should be greater, as necessary.

Further, as described above, concerning the elastic layers of image fixing endless belt 91 and pressure applying endless belt 95, a heat-resistant silicon rubber of thickness 200 μm (which is hardness JIS-A15°) can be used so that both belts softly contact each other, which results in higher image quality.

Still further, the elastic layers of image fixing endless belt 91 and pressure applying endless belt 95 can be formed to be electrically conductive, whereby the electrical voltage will be applied to the elastic layers, to serve as the electrical conductive layers, not being the belt bases. As the elastic layers exhibiting the electrical conductivity, a silicon rubber including carbon black, or the like, is preferable to use.

As understood by the above formula, when the distance between the members, to which the electrical voltage is applied, becomes shorter (“d” in this case represents the distance between the elastic members), attractive force F becomes greater. Accordingly, even if the manufacturing accuracy of the endless belts and the rollers is low, or even if the contacting condition between image fixing endless belt 91 and pressure applying endless belt 95 becomes uneven due to deterioration with age, contacting conditions will be changed to better condition by the above shorter distance. In addition, it is necessary to pay attention to the voltage endurance of the surface layers serving as the isolating members, the electrical discharge at the marginal surfaces of the endless belts, and the aerial discharge at the inlet and outlet areas of the nipping portion.

When surface layers 92C and 96C, structured of PFA exhibiting the thickness 30 μm, are used, in order to prevent aerial discharge at the inlet and outlet areas of the nipping portion, the voltage difference between image fixing endless belt 91 and pressure applying endless belt 95 should be set to be lower than 2400 V for an optimal by the Paschen effect. If it is set to be 2000V, electrical attractive force F is 5 kPa, which is effectively great.

Further, the electrical voltage is applied to the belt bases, in order to increase attractive force F, the thickness of the endless belt, which does not face the image, and having low influence on image quality, that is, the thickness of pressure applying endless belt 95, is set to be lower than the thickness of the endless belt which faces the image, that is, the thickness of the elastic layer of image fixing endless belt 91, being 100 μm, for example.

Still further, if there is no problem on the image quality, the elastic layer is not required to be formed on pressure applying endless belt 95.

Still further, in a case that the image fixing device is structured on a mono-chromatic image output apparatus, which has a larger tolerance level concerning uneven brightness, the elastic layer is also not required to be formed on image fixing endless belt 91.

In the structure describe above, nipping portion N, at which pressure applying endless belt 95 presses against image fixing endless belt 91, should be formed to be a flat surface, which is the most effective. If, instead, it is formed to be a curved surface, the slight difference, occurred between the lengths of routing lines of said two endless belts, would tend to create relative movement, resulting in partial image defects.

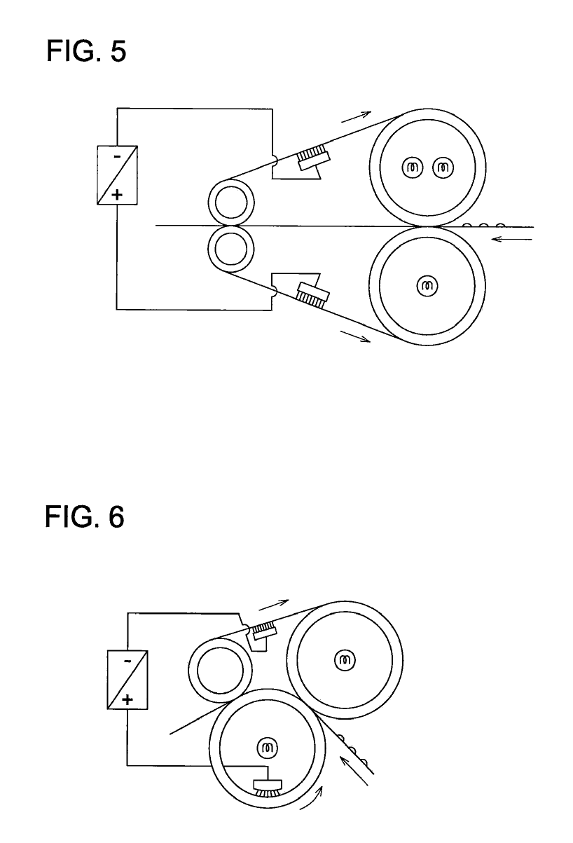

Accordingly, the belt type image fixing device shown in FIG. 5 is also effective.

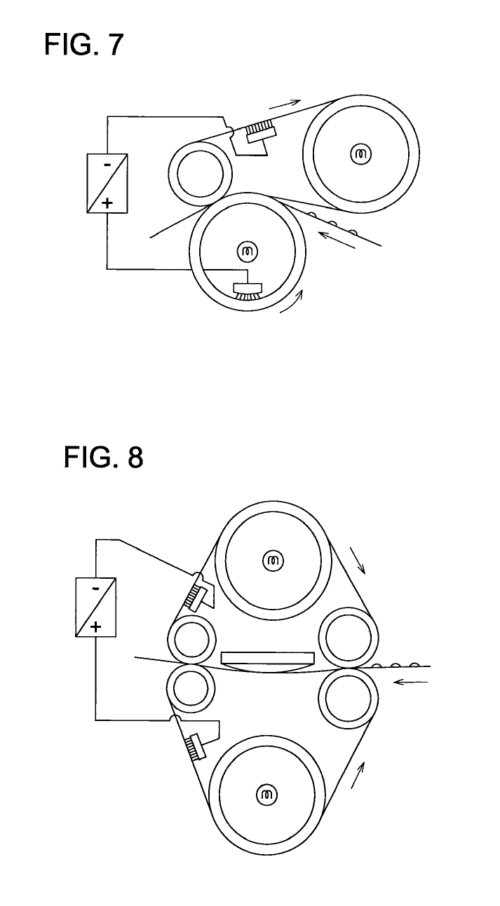

Further, on belt type image fixing devices shown in FIGS. 6 and 7, when the difference of the electrical voltages between an image fixing endless belt and a pressure applying roller (which serves as a pressure applying member) is used, said devices have some advantages, and become allowable on various variations.

Still further, in a case of a belt type image fixing device shown in FIG. 8, that is, a mechanical contacting member is provided so that two endless belts are in contact with each other, if a different electrical voltage is provided between the two endless belts, image defects due to the various variations can be controlled, which creates greater allowance for the accuracy.

Due to the belt type image fixing device and the image forming device using the same belt type image forming device, the toner image is evenly contacted against the image fixing belt by the simple structure so that image formation is effectively conducted without any image defects.

What is claimed is:

1. A belt type image fixing device, comprising:
an image fixing endless belt which is configured to include:
an electrically conductive layer; and
an insulation layer to cover the electrically conductive layer;
a pressure applying member to press against the image fixing endless belt, the pressure applying member is configured to include:
an electrically conductive layer; and
an insulation layer to cover the electrically conductive layer; and
an electrical voltage applying device which is configured to apply an electrical voltage to at least one of the electrical conductive layer of the image fixing endless belt and the electrical conductive layer of the pressure applying member,
wherein the image fixing endless belt and the pressure applying member form a nipping portion which nips and conveys a recording medium on which a toner image has been transferred, and
wherein a predetermined difference of electrical voltage is created between the image fixing endless belt and the pressure applying member.

2. The belt type image fixing device of claim 1,
wherein the pressure applying member comprises an endless belt.

3. The belt type image fixing device of claim 2,
wherein the electrical conductive layer of the image fixing endless belt comprises a belt base of the image fixing endless belt, and the electrical conductive layer of the pressure applying member comprises a belt base of the pressure applying member.

4. The belt type image fixing device of claim 2,
wherein the electrical conductive layer of the image fixing endless belt comprises an elastic member formed between the belt base and the surface layer of the image fixing endless belt, and the electrical conductive layer of the pressure applying belt comprises an elastic member formed between the belt base and the surface layer of the pressure applying belt.

5. The belt type image fixing device of claim 4,
wherein the elastic layer of the pressure applying endless belt is thinner than the elastic layer of the image fixing endless belt.

6. The belt type image fixing device of claim 2,
wherein the electrical voltage is applied to the image fixing endless belt and the pressure applying endless belt by a brush.

7. The belt type image fixing device of claim 2,
wherein the electrical voltage is applied to a roller entraining the image fixing endless belt and a roller entraining the pressure applying endless belt.

8. The belt type image fixing device of claim 1,
wherein the electrical voltage is applied to the electrical conductive layer of the image fixing endless belt and the electrical conductive layer of the pressure applying member, to apply an electrical force to toner in a direction from the pressure applying member to the image fixing endless belt, by an interaction of an electrical charge charged on the toner and an electrical field formed between the electrical conductive layer of the image fixing endless belt and the electrical conductive layer of the pressure applying member.

9. The belt type image fixing device of claim 1,
wherein a polarity of the electrical voltage to be applied to the image fixing endless belt differs from a polarity of the electrical voltage to be applied to the pressure applying member, and an absolute value of the electrical voltage applied to the image fixing endless belt is approximately equal to an absolute value of the electrical voltage applied to the pressure applying member.

10. The belt type image fixing device of claim 1,
wherein the electrical field at the nipping portion is set to be less than 4×10⁷ V/m.

11. The belt type image fixing device of claim 2,
wherein a width of the image fixing endless belt differs from a width of the pressure applying endless belt.

12. The belt type image fixing device of claim 11,
wherein the pressure applying endless belt is wider than the image fixing endless belt.

13. The belt type image fixing device of claim 2,
wherein the image fixing endless belt is mounted to be shifted from the pressure applying endless belt in a width direction, so that edges of the image fixing endless belt are not adjacent the edges of the pressure applying endless belt.

14. The belt type image fixing device of claim 2,
wherein the nipping portion is formed to be flat.

15. An image forming apparatus, having the belt type image fixing device of claim 1.
